(19) United States
(12) Patent Application Publication
(10) Pub. No.: US 2014/0215832 A1
(43) Pub. Date: Aug. 7, 2014

(54) Comb for Clippers

(71) Applicant: Pierre Julemont, Soumagne (BE)

(72) Inventor: Pierre Julemont, Soumagne (BE)

(73) Assignee: Babyliss Faco SPRL, Liege (BE)

(21) Appl. No.: 14/127,360

(22) PCT Filed: Jun. 20, 2012
(86) PCT No.: PCT/EP2012/061814

§ 371 Date: Mar. 28, 2014

(30) Foreign Application Priority Data
Jun. 24, 2011 (EP) 11171273.3

(51) Int. Cl. B26B 19/20; A45D 24/36; B26B 19/38

(52) U.S. Cl. CPC B26B 19/20; B26B 19/3813; A45D 24/36
USPC 30/200; 132/213.1

(57) ABSTRACT

The present invention relates to a removable comb (1) comprising a latch (5) enabling said comb (1) to be attached to clippers (6) during use, said latch (5) being positioned on an arch (3), the curvature of which increases when pressure is applied to the sides of the arch, the increase in curvature of the arch (3) leading to the unlatching of the comb (1).

### FIELD OF THE INVENTION

The present invention relates to a removable comb intended to be attached onto a hair or beard clipper, and more particularly to a comb comprising improved attachment means that makes changing the comb of the clipper easier.

### STATE OF THE ART

The clipper comb, also called cutting guide, is used for adjusting the cutting height for the hair or the hairs of a beard. Some existing cutting guides are firmly attached to the clipper, whose position can be adjusted by means of a control member that may be motor-driven. Moreover, there are removable combs of different sizes intended to be attached onto the head of the clipper by the user in order to adapt the cutting height.

In the latter case, many systems for locking the comb to the clipper are known. The comb may either be attached to the inside or to the outside of the clipper's head. Outer attachment systems are disclosed inter alia in patent applications CA 2,254,672 A1 and US 2008/0184565 A1, as well as in patent U.S. Pat. No. 4,614,036.

Patent applications CA 2,254,672 A1 and US 2008/0184565 1 show a comb that comprises at one end a flexible tab ensuring attachment onto the clipper's blade.

In U.S. Pat. No. 4,614,036, the comb is attached onto the clipper by means of a flexible tab positioned at the base of the comb and comprising a hook that may be engaged into one of the grooves found on the casing of the clipper.

The locking systems of the state of the art require direct handling of the tab in order to allow unlocking of the comb/clipper assembly. Now, it is not always easy to manipulate the lock either because it is not easy to access or because of the effort required for managing to unblock the system with the result that the user might break a nail.

### CLAIMS OF THE INVENTION

The present invention aims to provide a comb equipped with attachment means that do not have the drawbacks of the state of the art.

It thus aims to produce a comb equipped with easily accessible attachment means that do not require direct handling of the latch and only require a small effort from the user.

### MAIN CHARACTERISTIC ELEMENTS OF THE INVENTION

The present invention relates to a removable comb comprising a latch allowing, in use, to attach said comb onto a clipper, said latch being positioned on an arc, whose curvature increases when pressure is applied to the sides of the arc, the increase in curvature of the arc causing the unlocking of the comb.

According to particular embodiments of the invention, the comb comprises at least one or a suitable combination of the following characteristics:
the latch is positioned in the middle of the arc;
the latch comprises a protrusion cooperating with a complementary portion on the clipper;
said complementary portion is a fixed blade of the clipper or an adapter to be attached on the clipper;
the comb is a one-piece comb;
it comprises teeth with a set height comprised between 3 and 25 mm;
the arc is configured so that its deflection increases by a distance from 0.2 to 10 mm, preferably from 0.5 to 3 mm.

The present invention also relates to a clipper comprising a comb as described above.

### SHORT DESCRIPTION OF THE FIGURES

FIG. 1 illustrates three-dimensional views of combs as in the invention for three different cutting heights (3, 13 and 25 mm).

FIG. 2 illustrates a three-dimensional view of the comb/clipper assembly comprising the comb as in the invention.

FIG. 3 illustrates three-dimensional views of the comb as in the invention intended to be attached onto a removable adapter.

FIG. 4 illustrates three-dimensional views of the comb of FIG. 3 and of the clipper comprising the aforementioned adapter.

FIG. 5 illustrates by means of arrows the areas of the comb that are urged and deformed during the unlocking of the comb.

FIG. 6 illustrates a sectional view of the attachment of the comb as in the invention onto the head of the clipper blade (without any adapter).

FIG. 7 illustrates sectional views of how the comb as in the invention is attached onto the clipper (without any adapter).

FIGS. 8, 9 and 10 respectively illustrate three-dimensional views of the successive actions to be performed by the user for detaching the comb from the clipper. As an example, the actions are illustrated for the comb as in the invention that is attached onto the fixed blade of the clipper (without any adapter). The arrows indicate the sides of the arc that are pressed for increasing the curvature thereof, allowing to unlock the comb.

### KEY

(1) Comb
(2) Comb tooth
(3) Curved portion, also called arc
(4) Side of the arc with lateral bearing surface
(5) Latch
(6) Clipper
(7) Tab
(8) Protrusion
(9) Fixed blade
(10) Attachment edge
(11) Opening
(12) Adapter

### DETAILED DESCRIPTION OF THE INVENTION

The present invention relates to a removable comb for a clipper, and more particularly to the means for attaching said comb to the clipper. The clipper may be a beard or hair clipper or be intended for animal use.

The comb 1 as in the invention is illustrated in

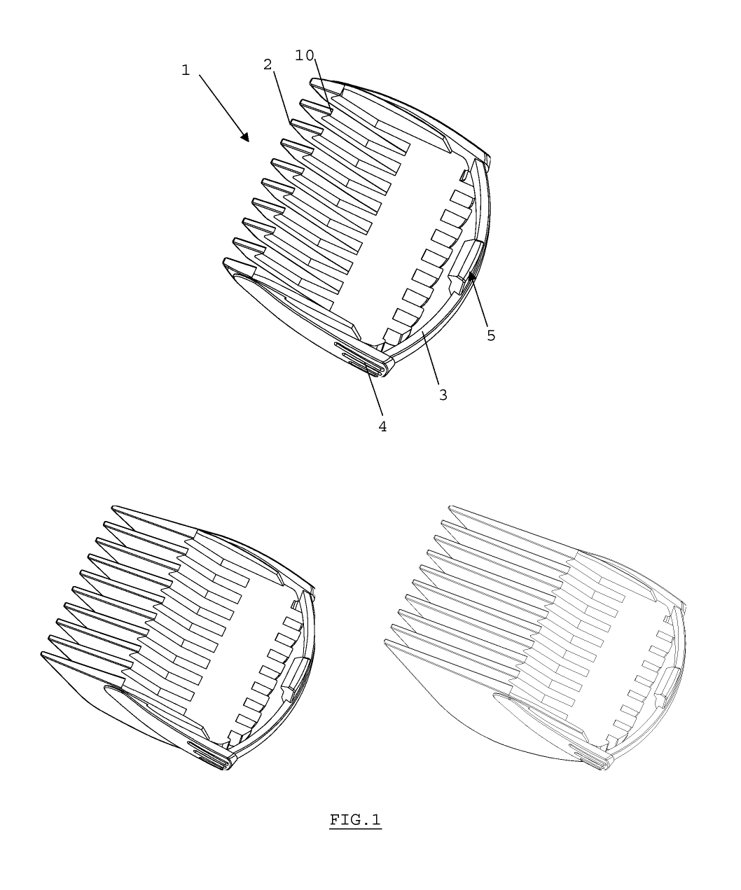

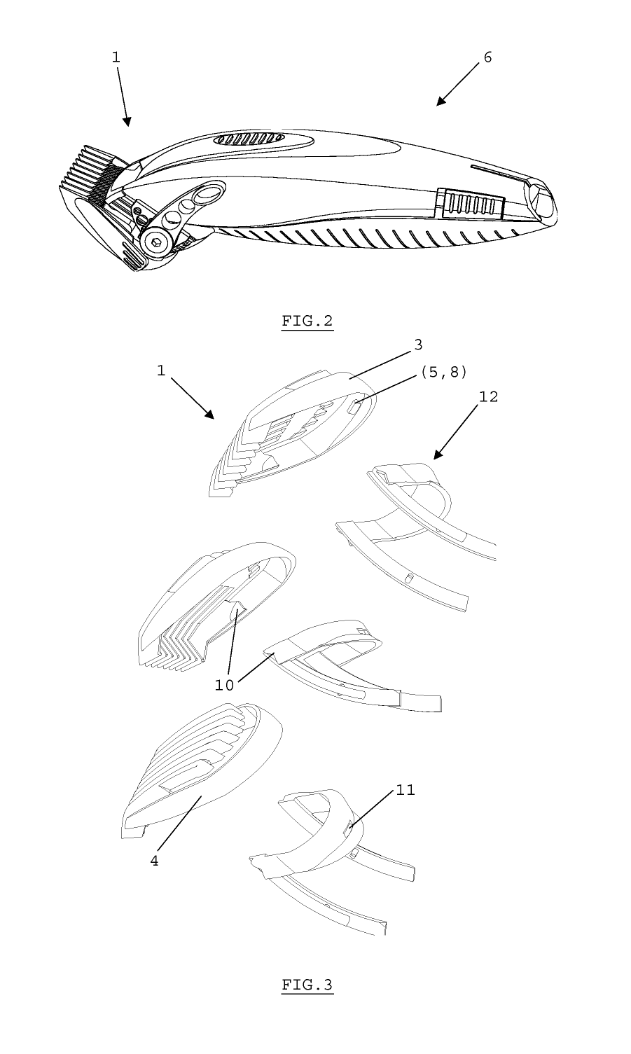

FIGS. 1 and 3 for different cutting heights. It is provided with teeth 2 on its face intended to be put into contact with the skin. On the opposite side, it comprises an arc-shaped flexible curved portion 3 that is preferably made in a plastic material integral with the whole of the comb (one-piece structure).

The arc 3 comprises two lateral bearing surfaces 4 intended to be pinched by the user upon unlocking the comb/clipper assembly. The lateral bearing surfaces may equally be comprised in the continuity of the arc as in

FIG. 3 or form distinctive surfaces of the arc with, for example, a raised portion or grooves as in FIG. 1.

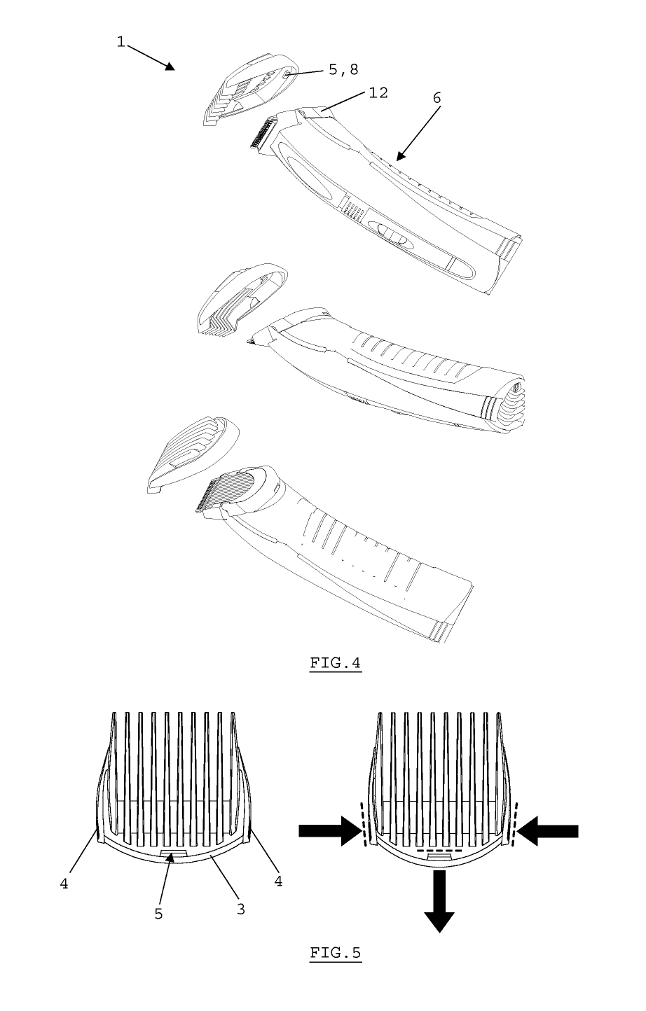

The arc 3 comprises a latch 5 ensuring the attachment of the comb 1 onto the clipper 6 (see FIGS. 4 and 7). More specifically, the latch ensures the attachment of the comb onto the fixed blade 9 of the clipper as illustrated in FIG. 7 or onto an adapter 12 that may be removably mounted on the clipper as shown in FIGS. 3 and 4.

The latch 5 is positioned in the middle of the arc and it comprises a protrusion 8 cooperating with the fixed blade 9 or with the adapter 12. The protrusion 8 may be positioned at the top of a tab 7 rising from the arc 3 in a direction that is substantially perpendicular to the plane formed by the lateral bearing surfaces 4 and the arc (see FIGS. 1 and 7). This protrusion 8 will grip the fixed blade 9 of the comb upon locking the comb on the clipper. The protrusion 8 may also be positioned on the arc 3 and be housed upon locking in an opening 11 provided in the adapter 12 (see FIG. 3).

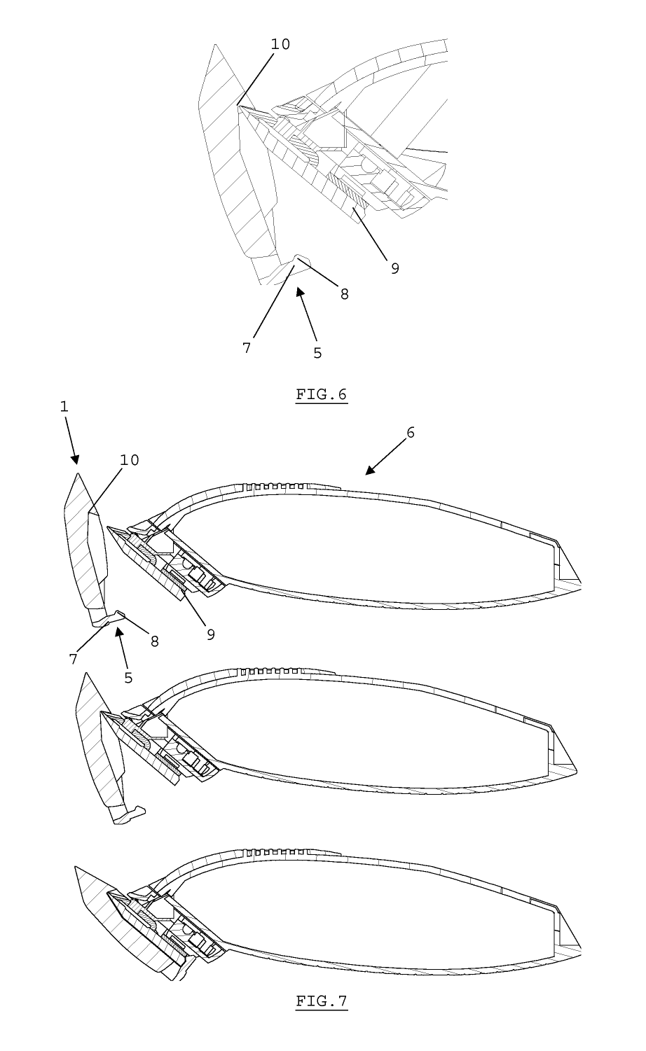

At least one of the teeth 2 of the combs comprises an attachment edge 10 positioned inside the tooth. As illustrated in FIGS. 4 and 6, the attachment edges 10 are configured for attaching the head of the fixed blade of the clipper. The attachment edges 10 may also allow attachment to the adapter 12, which is itself provided with attachment means 10 (see FIG. 3).

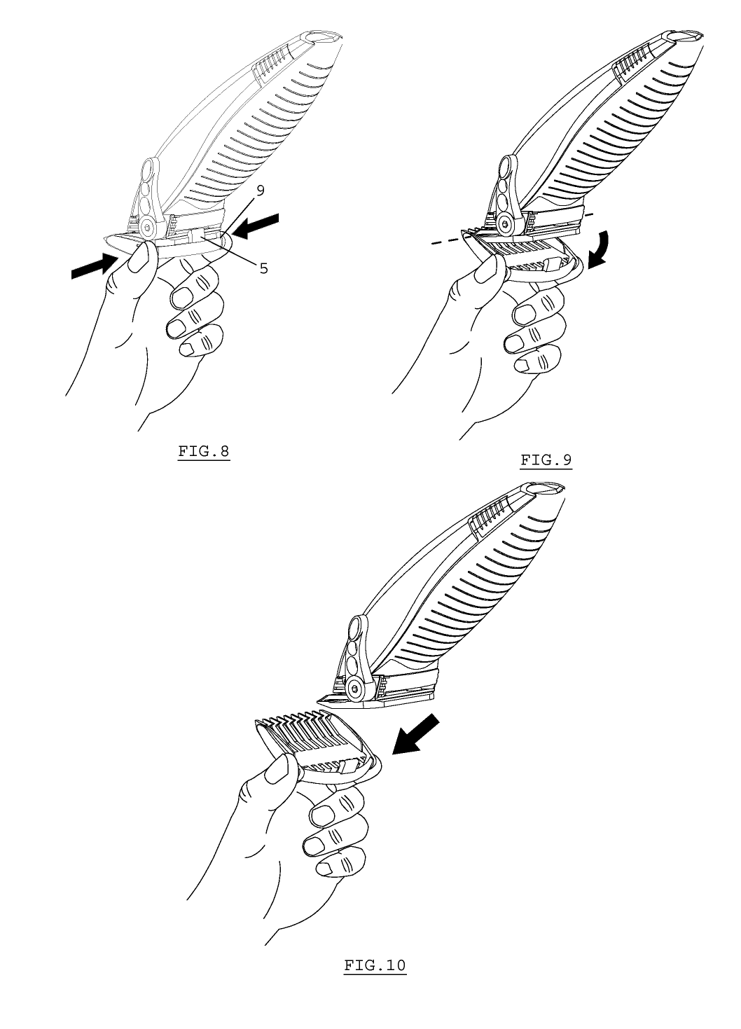

During use, upon unlocking of the comb/clipper assembly, the user will pinch the lateral bearing surfaces 4 of the comb as illustrated in FIGS. 5 and 10, which results in that the deflection of the arc 3 significantly increases by a distance of the order of 0.2 to 10 mm, preferably from 0.5 to 3 mm. Thus, during the unlocking operation illustrated in FIGS. 8-10, the latch 5 is detached from the fixed blade 9 or from the adapter if the clipper is provided with an adapter. The user then only has to remove the comb from the head of the blade.

### ADVANTAGES OF THE COMB AS IN THE INVENTION

The comb may be made at a low cost due to its one-piece structure.

The comb may be easily detached from the clipper by the user. Thus, unlocking is carried out indirectly by means of the lateral bearing surfaces and consequently does not require any manipulation of the latch as such.

1. A removable comb (1) comprising a latch (5) allowing, in use, to attach said comb (1) onto a clipper (6), said latch (5) being positioned on an arc (3), the curvature of which increases when pressure is applied on the sides of the arc, the increase in the curvature of the arc (3) causing the comb (1) to unlock.

2. The comb (1) as in claim 1, wherein the latch (5) is positioned in the middle of the arc (3).

3. The comb (1) as in claim 1, wherein the latch (5) comprises a protrusion (8) cooperating with a complementary portion on the clipper (6).

4. The comb (1) as in claim 3, wherein said complementary portion is a fixed blade (9) of the clipper or an adapter (12) to be attached onto the clipper (6).

5. The comb (1) as in claim 1, wherein the comb (1) is a one-piece comb.

6. The comb (1) as in claim 1, wherein the comb (1) comprises teeth (2) with a set height comprised between 3 and 25 mm.

7. The comb (1) as in claim 1, wherein the arc (3) is configured so that its deflection increases from 0.2 to 10 mm, preferably from 0.5 to 3 mm.

8. A clipper (6) comprising a comb (1) as in claim 1.
